(19) United States
(12) Patent Application Publication
(10) Pub. No.: US 2008/0111442 A1
(43) Pub. Date: May 15, 2008

(54) Brush holder

(76) Inventor: Torsten Tussing, Koengen (DE)

Correspondence Address: ABELMAN, FRAYNE & SCHWAB, 666 THIRD AVENUE, 10TH FLOOR, NEW YORK, NY, 10017, US

(21) Appl. No.: 11/985,303

(22) Filed: Nov. 13, 2007

(30) Foreign Application Priority Data
Nov. 14, 2006 (DE) 10 2006 035 440.0

(51) Int. Cl. H01R 39/44; H01R 39/41

(52) U.S. Cl. 310/242

(57) ABSTRACT

A brush holder (2) has a carbon holder (4) which forms a guide (12) for a carbon brush (6) and at which there is provided a spring arrangement that applies a contact spring force (KF) to the carbon brush (6) along the guide (12) and, at the same time, presses the carbon brush (6) into a taper (23) of the guide (12) with a supporting spring force (SF), with the spring arrangement having a contact spring (8) for generating the contact spring force (KF) and a supporting spring (28) which is separate from the latter and which generates the supporting spring force (SF).

### BACKGROUND OF THE INVENTION

1. Field of the Invention

The invention is directed to a brush holder having a carbon holder which forms a guide for carbon brushes, spring means provided at the carbon holder for applying a contact spring force to the carbon brush along a guide axis of the guide. At the same time, the spring means biases the carbon brush transverse to the guide axis into a taper of the guide with a supporting spring force, and the carbon brush has a corresponding taper which cooperates with the taper of the guide.

2. Description of the Prior Art

In brush holders of the type mentioned above, the carbon brushes are held in the carbon holders in a relatively stable manner. The spring means ensures that the carbon brushes are biased in direction of a commutator and that the carbon brushes are supported in the carbon holders laterally so as to be substantially free of play. Possible wear at the side surfaces of the carbon brushes is compensated in that the carbon brushes are pressed farther into the tapering area of the guide transverse to the actual guiding direction.

German Patent DE 33 46 595 C2 discloses a brush holder for electric machines which has a carbon holder for guiding a carbon brush scroll spring means is provided at the carbon holder and applies pressure to the carbon brush with an inclined application surface of a pressure sliding piece along the guide and transverse thereto. The carbon brush is pressed to one side of the carbon holder on which a taper is formed by two inclined supporting surfaces.

The drawback of the known brush holder consists in that the scroll spring means and the bearing means, which is required for the latter on the brush holder, are relatively costly to produce. Accordingly, the costs of producing the brush holder as a whole is relatively high. In addition, the supporting pressure that can be generated by the scroll spring means is relatively small so that strong vibrations can lead to a tilting of the carbon brush in the carbon holder and, therefore, to accelerated wear in some areas.

### SUMMARY OF THE INVENTION

It is an object of the present invention to provide a brush holder in which the drawbacks of a know brush holder are eliminated and an improved lateral support of the carbon brush is achieved by using simple spring means.

This and other objects of the present invention, which will become apparent hereinafter, are achieved by providing a brush holder in which the spring means includes a contact spring for generating a contact spring force and a supporting spring which is separate from the contact spring and which generates a supporting spring force. With this functional separation, it is possible to design the supporting spring that generates the supporting pressure, independently from the contact spring and in such a way that a sufficient lateral supporting pressure is applied to the carbon brush so as to hold it permanently in contact with the inclined guide surface when strong vibrations occur in operation. In this way, tilting of the carbon brush and resulting increased wear in some areas can be reduced to a minimum or completely eliminated.

The taper is advantageously formed by a guide surface on a first guide side of the guide and by an adjacent, second guide side. The guide surface and the second guide side enclose an acute angle. In this way, by forming a corresponding taper at the carbon brush which defines a corner angle substantially corresponding to the acute angle, a stable support of the carbon brush can be ensured at all times even after a very long period of operation and a corresponding lateral wear.

The guide at the first guide side is advantageously delimited exclusively by the inclined guide surface. With such a single inclined guide surface, the production costs for both the carbon holder and the carbon brush are noticeably reduced. On the other hand, lateral wear, which occurs at the carbon brush over its lifetime, can be compensated in an excellent manner in this way.

In a particularly preferred embodiment, the guide is delimited on its third guide side located opposite the first guide side exclusively by the supporting spring. This makes possible to apply pressure to the carbon brush in a very uniform manner and over a maximum surface. In this way, the carbon brush can be subjected to action of a relatively high supporting spring force which, in turn, also prevents tilting of the carbon brush in the carbon holder even with strong vibrations.

In this connection, it is advantageous when the supporting spring is formed by a leaf spring to ensure an economical production of the supporting spring.

The supporting spring advantageously has a clamping portion which is clamped between a carrier of the brush holder and the carbon holder. Further, the supporting spring has an application portion which projects into the carbon holder and forms the third guide side. In this way, the supporting spring and its bearing means at the brush holder can be constructed in a particularly simple manner which reduces production cost.

The application portion can preferably contact the carbon brush over a length amounting to at least 80% of the length of the guide surface along the guide axis. In this way, the supporting pressure can be applied over almost the entire length of the guide so that formation of areas with increased wear can be prevented to a great extent.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a perspective view of a brush holder according to the present invention;

FIG. 2 a cross-sectional view of a carbon holder of the brush holder shown in FIG. 1;

FIG. 3 a longitudinal cross-sectional view of the carbon holder in plane 3 in FIG. 2; and

FIG. 4 a longitudinal cross-sectional view of the carbon holder shown in FIG. 3, with the carbon brush omitted.

### DETAILED DESCRIPTION OF THE PREFERRED EMBODIMENT

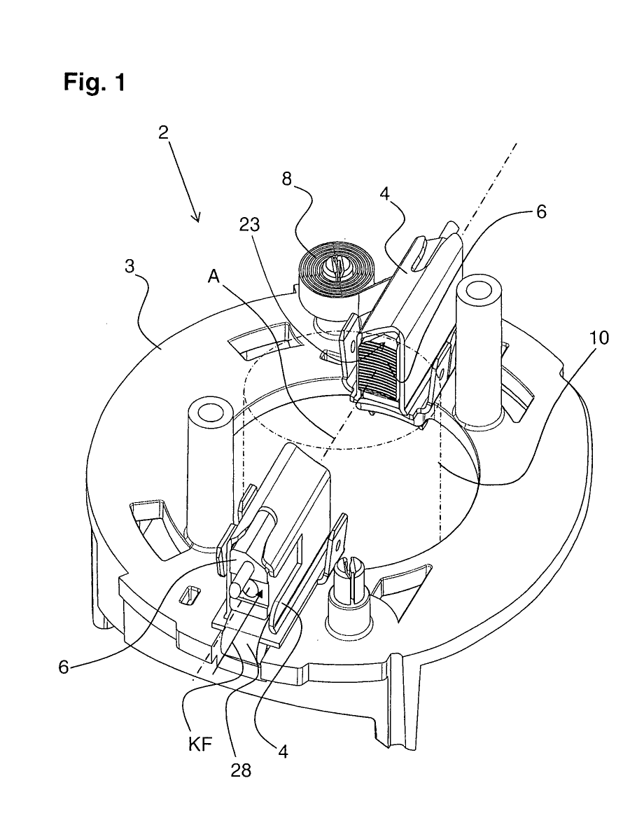

FIG. 1 shows a brush holder 2, particularly for a hand-held power tool, not shown, with a substantially ring-shaped carrier 3 that supports two carbon holders 4. Carbon brushes 6 are guided in these carbon holders 4, with each carbon brush 6 being biased against a commutator 10 by a contact spring force KF generated by a contact spring 8. The contact springs 8 are formed, for example, as coil springs. For the sake of clarity, only one contact spring 8 is shown.

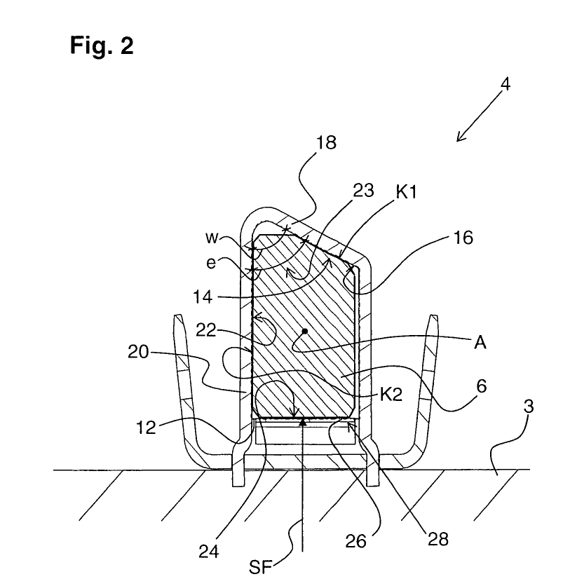

To guide a respective carbon brush 6, each carbon holder 4 forms a substantially four-sided guide 12 along a guide axis A, as can be seen particularly from FIG. 2. A first guide side 14 remote from the carrier 3 is substantially formed by a guide surface 16 of a holder wall 18 which is arranged at an inclination to a second guide side 22 formed by a holder wall 20, and encloses therewith an acute angle w. Accordingly, the guide surface 16 together with the second guide surface 22, forms a taper 23 directed transverse to the guide axis A.

As an alternative to delimiting the guide 12 on the first guide side 14 completely by the inclined guide surface 16, the first guide side 14 can also be formed only partly by the guide surface 16, while another part is formed by an area of the holder wall 18 directed at a right angle to the second guide side 22.

At a third guide side 24 which faces the carrier 3 and is located opposite to the first guide side 14, the guide 12 is delimited exclusively by an application portion 26 of a supporting spring 28 which projects into the carbon holder 4. This supporting spring 28 presses the respective carbon brush 6 with a supporting spring force SF in direction of the first guide side 14 and, accordingly, into the taper 23. In this way, the carbon brush 6 contacts the first guide side 14 with a first contact surface K1 at the inclined guide surface 16 and contacts the second guide side 22 with a second contact surface K2 at the holder wall 20. The carbon brush 6 defines a corner angle e between the two contact surfaces K1, K2, which corner angle e substantially corresponds to the acute angle w of the taper 23. Accordingly, the contact surfaces K1, K2 form a taper on the brush side which is adapted to the taper 23 on the guide side.

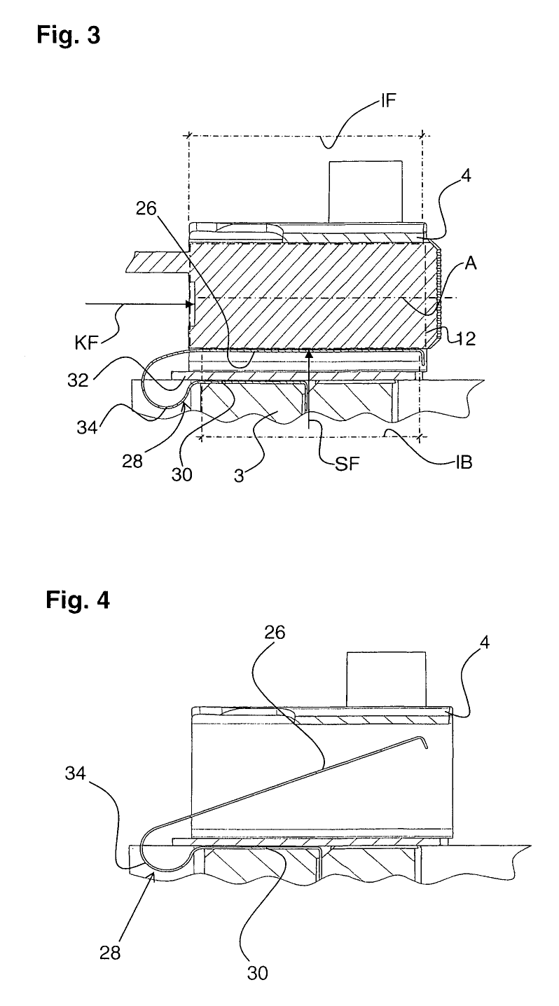

As can be seen from FIG. 3, the supporting spring 28 is formed as a leaf spring which has a clamping portion 30 at an end remote from the application portion 26. This clamping portion 30 is secured between the carrier 3 and a holder bearing wall 32 of the respective carbon holder 4 facing the carrier 3. The application portion 26 and the clamping portion 30 are connected to one another by a tab portion 34 with which the supporting spring force SF can be produced.

For this purpose, the tab portion 34 is designed in such a way that, in an unloaded state according to FIG. 4 in which no carbon brush 6 is arranged in the carbon holder 4, the supporting spring 28 has a substantially V-shaped form in which the application portion 26 and the clamping portion 30 are arranged at an inclination to one another.

However, in the operating state, with the carbon brush 6 being installed, shown in FIG. 3, the application portion 26 is pressed to the side in such a way that it lies substantially parallel to the clamping portion 30. The tab portion 34 is elastically deformed and now, as a result of elastic restoring forces acting upon it, generates the supporting spring force SF which acts on the carbon brush 6 by means of the application portion 26.

To ensure that the carbon brush 6 is pressed against the inclined guide surface 16 in a particularly uniform manner, the application portion 26 has a length IB which can contact the carbon brush 6 and which is at least 80% of a length IF of the guide surface extending along the guide axis A.

Accordingly, over the lifetime of the carbon brush 6, this carbon brush 6 is pressed increasingly into the taper 23 by the supporting spring 28 as lateral wear on the contact surfaces K1 and K2 increases. The carbon brush 6 is always guided in a stable manner along the guide surface 16 directed parallel to the first contact surface K2 and the holder side wall 20 which is directed substantially parallel to the second contact surface K2. Accordingly, when a sufficiently high supporting spring force SF is applied, a tilting of the carbon brush 6 inside the carbon holder 4 can be prevented to a large extent even after a long operating period and under strong vibrations.

Though the present invention was shown and described with references to the preferred embodiment such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A brush holder (2), comprising a carbon holder (4) which forms a guide (12) for a carbon brush (6), and spring means for applying a contact spring force (KF) to the carbon brush (6) along the guide (12) and for simultaneously pressing the carbon brush (6) into a taper of the guide (12) by a supporting spring force (SF), the spring means having a contact spring (8) for generating the contact spring force (KF) and a supporting spring (28) for generating the supporting spring force (SF) and separate from the contact spring.

2. A brush holder according to claim 1, wherein the taper is formed by a guide surface (16) at a first guide side (14) of the guide (12) and by an adjacent, second guide side (22), and wherein the guide surface (16) and the second guide side (22) enclose an acute angle (w).

3. A brush holder according to claim 2, wherein the guide (12) at the first guide side (14) is delimited exclusively by the inclined guide surface (16).

4. A brush holder according to claim 1, wherein the guide (12) is delimited exclusively by the supporting spring (28) at a third guide side (24) located opposite the taper.

5. A brush holder according to claim 4, wherein the supporting spring (28) is formed by a leaf spring.

6. A brush holder according to claim 5, wherein the supporting spring (28) has a clamping portion (30) located between a carrier (3) of the brush holder (2) and the carbon holder (4) and having an application portion (26) which projects into the carbon holder (4) and forms the third guide side (24).

7. A brush holder according to claim 6, wherein the application portion (26) makes contact over a length (IB) amounting to at least 80% of a length (IF) of the guide surface (16).
